(19) United States
(12) Patent Application Publication
(10) Pub. No.: US 2019/0138786 A1
(43) Pub. Date: May 9, 2019

(54) SYSTEM AND METHOD FOR IDENTIFICATION AND CLASSIFICATION OF OBJECTS

(71) Applicant: SIGHTLINE INNOVATION INC., Toronto (CA)

(72) Inventors: Wallace TRENHOLM, Toronto (CA); Mark ALEXIUK, Winnipeg (CA); Hieu DANG, Winnipeg (CA); Siavash MALEKTAJI, Winnipeg (CA); Kamal DARCHINIMARAGHEH, Winnipeg (CA)

(21) Appl. No.: 15/997,917

(22) Filed: Jun. 5, 2018

Related U.S. Application Data
(60) Provisional application No. 62/515,652, filed on Jun. 6, 2017.

(51) Int. Cl. G06K 9/00; G06K 9/62; G06K 9/40; G06K 9/46

(52) U.S. Cl. CPC G06K 9/00208; G06K 9/6268; G06K 9/40; G06K 2209/27; G06K 9/4604; G06K 9/4676; G06K 9/6256; G06K 9/6227

(57) ABSTRACT

A method and system for analysis of an object of interest in a scene using 3D reconstruction. The method includes: receiving image data comprising a plurality of images captured of the scene, the image data comprising multiple perspectives of the scene; generating at least one reconstructed image by determining three-dimensional structures of the object from the imaging data using a reconstruction technique, the three-dimensional structures comprising depth information of the object; identifying the object from each of the reconstructed images, using a trained machine learning model, by segmenting the object in the reconstructed image, segmentation comprises isolating patterns in the reconstructed image that are classifiable as the object, the machine learning model trained using previous reconstructed multiple perspective images with identified objects; and outputting the analysis of the reconstructed images.

### TECHNICAL FIELD

The present disclosure relates to imaging interpretation. More particularly, the present disclosure relates to a system and method for identifying and classifying objects using 3D reconstruction and neural networks.

### BACKGROUND

In many applications, imaging can be used to garner information about an object; for example, imaging can provide a convenient means of object identification. However, issues of occlusion or obstruction and the presence of clutter can often hinder or prevent accurate identification of objects via imaging, by obscuring useful information about the object that can aid in its correct identification. The inability to accurately and reliably identify an object via imaging with minimal human intervention precludes the application of some imaging techniques as a means of object identification, particularly as part of industrial or commercial processes and applications.

Accordingly, a system and method for object identification and classification is desired that reduces the impact of occlusion and related issues on the ability to accurately and reliably identify objects in an image.

### SUMMARY

In an aspect, there is provided a method for analysis of an object of interest in a scene using 3D reconstruction, the method executed on one or more processors, the method comprising: receiving image data comprising a plurality of images captured of the scene, the image data comprising multiple perspectives of the scene; generating at least one reconstructed image by determining three-dimensional structures of the object from the imaging data using a reconstruction technique, the three-dimensional structures comprising depth information of the object; identifying the object from each of the reconstructed images, using a trained machine learning model, by segmenting the object in the reconstructed image, segmentation comprises isolating patterns in the reconstructed image that are classifiable as the object, the machine learning model trained using previous reconstructed multiple perspective images with identified objects; and outputting the analysis of the reconstructed images.

In a particular case, the generating at least one reconstructed image, further comprises: detecting a plurality of features of the object, each of the features defining one or more key points, each of the features having a relatively high contrast for defining the one or more key points; tracking the plurality of features across each of the plurality of images; generating a sparse point cloud of the plurality of features using bundle adjustment with respect to a local reference frame; densifying the sparse point cloud; and performing surface reconstruction on the densified point cloud.

In another case, detecting the plurality of features comprises utilizing one or more binary descriptors selected from the group consisting of binary robust independent elementary features (BRIEF), binary robust invariant scalable keypoints (BRISK), oriented fast and rotated BRIEF (ORB), Accelerated KAZE (AKAZE), and fast retina keypoint (FREAK).

In yet another case, tracking the plurality of features across each of the plurality of images comprises associating key points from each of the plurality of images to a same three-dimensional point by utilizing at least one of gradient location and orientation histogram (GLOH), speeded-up robust features (SURF), scale-invariant feature transform (SIFT), and histogram of oriented gradients (HOG).

In yet another case, the local reference frame comprises a location and orientation of one or more imaging devices used to capture the plurality of images.

In yet another case, densifying the sparse point cloud comprises comparing patches around at least some of the key points across multiple perspectives for similarity and where the similarity of the patches from multiple perspectives is within a predetermined threshold, adding such patches to the point cloud.

In yet another case, the analyzing of each of the reconstructed images further comprises pre-processing of at least one of the plurality of images using one or more pre-processing techniques, the pre-processing techniques selected from a group consisting of decomposing a video sequence into the plurality of images, generating high dynamic range images by combining multiple low dynamic range images acquired at different exposure levels, color balancing, exposure equalization, local and global contrast enhancement, denoising, and color to grayscale conversion.

In yet another case, trained machine learning model takes as input and is further trained using multiple perspective two-dimensional projections of objects generated from the reconstructed image.

In yet another case, each two-dimensional projection has associated with it an independently trained classifier in the trained machine learning model to identify the object, and wherein each of the independently trained classifiers are aggregated and fed to a final classifier to produce a final classification to identify the object.

In yet another case, identifying the object from each of the reconstructed images, using a trained machine learning model, comprises splitting the reconstructed image into a plurality of voxels, and training the machine learning model using the voxels.

In yet another case, the segmentation comprises using at least one of RANSAC, Hough Transform, watershed, hierarchical clustering, and iterative clustering.

In another aspect, there is provided a system for analysis of an object of interest in a scene using 3D reconstruction, the system comprising one or more processors, a data storage device, an input interface for receiving image data comprising a plurality of images captured of the scene, and an output interface to output the analysis, the image data comprising multiple perspectives of the scene, the one or more processors configured to execute: a reconstruction module to generate at least one reconstructed image by determining three-dimensional structures of the object from the imaging data using a reconstruction technique, the three-dimensional structures comprising depth information of the object; and an artificial intelligence module to identify the object from each of the reconstructed images, using a trained machine learning model, by segmenting the object in the reconstructed image, segmentation comprises isolating patterns in the reconstructed image that are classifiable as the object, the machine learning model trained using previous reconstructed multiple perspective images with identified objects provided to the artificial intelligence module.

In a particular case, the image data from each of the different perspectives is captured using a different image acquisition device.

In another case, the image data from each of the different perspectives is captured using a single image acquisition device sequentially moved to each perspective.

In yet another case, each of the plurality of images have exchangeable image file format (EXIF) data associated with it, the EXIF data comprising at least one of date and time information, geolocation information, image orientation and rotation, focal length, aperture, shutter speed, metering mode, and ISO, and wherein the reconstruction module uses the EXIF data to calibrate the plurality of images to facilitate reconstruction.

In yet another case, the reconstruction module determines the three-dimensional structures using a structure-to-motion technique, the structure-to-motion technique uses the plurality of images captured of the object in a plurality of orientations, determines correspondences between images by selecting relatively high-contrast that have gradients in multiple directions, and tracks such correspondences across images.

In yet another case, the reconstruction module determines the three-dimensional structures using a shape-from-focus technique, the shape-from-focus technique uses the plurality of images captured with an image acquisition device having a very short depth-of-focus, where the plurality of images are captured with such lens moving through a range of focus, the reconstruction module determines a focal distance that provides the sharpest image of a plurality of features of the object and corresponds such distance to that feature of the object.

In yet another case, the reconstruction module determines the three-dimensional structures using a shape-from-shading technique, the surface of the object having a known reflectance, the shape-from-shading technique using the plurality of images captured by a plurality of image capture devices using illumination from a light source of known direction and intensity, where a brightness of the surface of the object corresponds to a distance and surface orientation relative to the light source and the respective image acquisition device, the reconstruction module determining gray values from each respective surface to provide a distance to the object, where each of the image capture devices approximately simultaneously image the scene and differences in location of each feature in each acquired image provide separation of each point in three-dimensional space.

In yet another case, the reconstruction module generates the at least one reconstructed image by: detecting a plurality of features of the object, each of the features defining one or more key points, each of the features having a relatively high contrast for defining the one or more key points; tracking the plurality of features across each of the plurality of images; generating a sparse point cloud of the plurality of features using bundle adjustment with respect to a local reference frame; densifying the sparse point cloud; and performing surface reconstruction on the densified point cloud.

In yet another case, trained machine learning model takes as input and is further trained using multiple perspective two-dimensional projections of objects generated from the reconstructed image.

These and other aspects are contemplated and described herein. It will be appreciated that the foregoing summary sets out representative aspects of systems and methods to assist skilled readers in understanding the following detailed description.

### BRIEF DESCRIPTION OF THE DRAWINGS

Preferred embodiments of the present disclosure will now be described, by way of example only, with reference to the attached figures, wherein:

FIG. 1 is a schematic diagram of a neural network-based system for identifying and classifying objects (in a 3D reconstructed image), in accordance with an embodiment;

FIG. 2 shows a method for performing object classification by acquiring multiple images, performing 3D reconstruction, followed by segmentation and identification of object of interest, in accordance with an embodiment;

FIG. 3 shows a block diagram of steps involved in performing 3D reconstruction from multiple images;

FIG. 4 shows a block diagram of steps involved in pre-processing the images and creating a feature track graph;

FIG. 5 shows a block diagram of steps involved in nonlinear optimization of 3D coordinates and increasing point cloud density;

FIG. 6 shows a block diagram of steps involved in surface reconstruction from point cloud data and generating output model for further processing;

FIG. 7 shows block diagram of steps involved in developing artificial intelligence models to learn (i) multi-orientation 3D representations of object of interest and (ii) multi-view 2D projections of object of interest;

FIG. 8 shows block diagram of steps involved in using a previously trained artificial intelligence models to classify objects in a 3D image;

FIG. 9 shows block diagram of steps involved in using a previously trained artificial intelligence models to classify objects in a static 2D image.

### DETAILED DESCRIPTION

Embodiments will now be described with reference to the figures. For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

One or more systems or methods described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud based program or system, laptop, personal data assistants, cellular telephone, smartphone, or tablet device.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The following relates to imaging interpretation and more particularly to a system and method for object identification and classification using 3D reconstruction and neural networks.

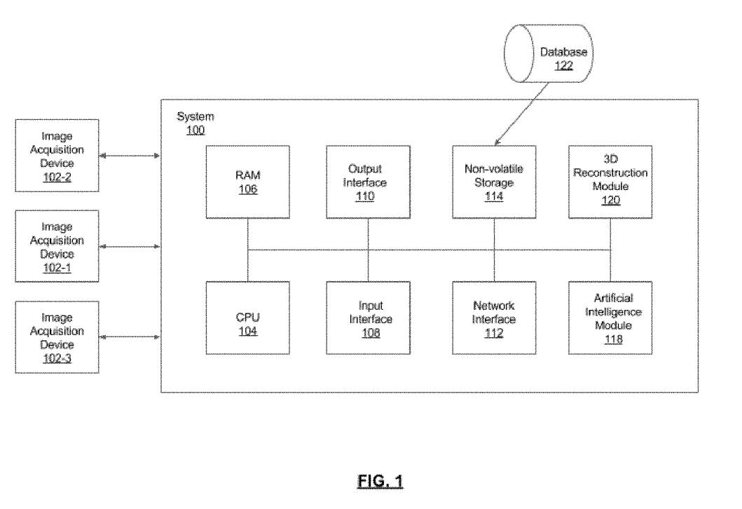

Referring now to FIG. 1, shown therein is a schematic diagram for a neural network-based system 100 for object identification and classification using 3D reconstruction, in accordance with an embodiment. As shown, the system 100 has a number of physical logical components, including a central processing unit (“CPU”) 104, random access memory (“RAM”) 106, an input interface 108, an output interface 110, a network interface 112, non-volatile storage 114, and a local bus 116 enabling CPU 104 to communicate with the other components. CPU 104 can include one or more processors. RAM 106 provides relatively responsive volatile storage to CPU 104. The input interface 108 enables an administrator to provide input via a keyboard and a mouse. In further cases, the input interface 108 can receive data from another computing device or from various data storage elements or devices, as described herein. The output interface 110 outputs information to output devices, such as a display and/or speakers. The network interface 112 permits communication with other systems or computing devices. Non-volatile storage 114 stores an operating system and programs, including computer-executable instructions for implementing an image acquisition device or analyzing data from the image acquisition device, as well as any derivative or related data. In some cases, this data can be stored in a database 122. During operation of the system 100, the operating system, the programs, and the data may be retrieved from the non-volatile storage 114 and placed in RAM 106 to facilitate execution. In an embodiment, the CPU 104 can be configured to execute a reconstruction module 120 and an artificial intelligence (“AI”) module 118.

In present embodiments, the system 100 can be used to reconstruct a 3D image of a scene from 2D image data containing an object of interest, detect features associated with the object of interest in the 3D reconstructed scene, and classify the object of interest based on the detected features. In a particular case, the object of interest is a purchased item such as a tool and system 100 is used to identify the item as part of an inventory verification process in a supply chain. Embodiments are also contemplated in which the system 100 is used to detect and, in some cases, categorize features comprising defects in an imaged object. Such defects may be due to manufacturing-related errors or other conditions; in such cases, system 100 may be used as part of a quality-control or quality-assurance operation.

In some cases, image data can be provided to the system 100 by at least one image acquisition device 102 (image acquisition device 102-1, 102-2, 102-3). Collectively, image acquisition devices 102-1, 102-2, 102-3 are referred to as image acquisition devices 102, and generically as image acquisition device 102. Image acquisition device 102 may be connected to the system 100 directly or via a network; for example, the Internet. The components of the system 100 and the image device 102 can be interconnected by any form or medium of digital data communication; for example, a communication network. Examples of communication networks include a local area network (“LAN”) and a wide area network (“WAN”), e.g., the Internet. In some embodiments, image data is provided directly to system 100 via image acquisition device 102, while other embodiments may have image data already acquired by the image acquisition device 102 and provided to system 100 by an external storage or other such device. Imaging devices 102 may provide system 100 with image data independently of one another (e.g. if each is connected independently to system 100), or image data from multiple imaging devices 102 may be first collected and sent together (e.g. in a batch) to system 100.

Image device 102 may be configured to acquire multiple images of a scene (to provide depth information), the scene containing an object of interest that a user wants to identify and classify. In some embodiments, the user may want to detect and potentially categorize a defect in an object. The multiple images may be acquired from multiple angles or perspectives in the hope of avoiding issues relating to occlusion, which may hinder the effectiveness of an object identification and classification process. In some embodiments, multiple image devices 102 are used to acquire multiple images from multiple perspectives; for example, image device 102-1 acquires an image from a first perspective, image device 102-2 acquires an image from a second perspective, and image device 102-3 acquires an image from a third perspective. The image device 102 can be configured to acquire two-dimensional (2D) or three-dimensional (3D) images of the scene. Image device 102 may acquire images continuously, such as video, by using a video camera or a camera in burst mode. While multiple images need not be taken in immediate succession, it may be desired so as to limit any significant degradation or alteration to the form of the object of interest (e.g. a rapidly melting ice sculpture). Severe degradation to the object of interest or alteration to its form before multiple images are acquired by image device 102 may prevent effective feature mapping between images acquired from adjacent viewpoints. This may produce imperfect 3D reconstruction of the object, which can further result in imperfect segmentation, identification and classification of the object of interest. In variations, image device 102 may be a video camera, single lens reflex camera, point and shoot camera, embedded camera (such as in a mobile device such as a cell phone or tablet computer), or other suitable device for acquiring 2D or 3D image data (e.g. lidar), or some combination thereof.

In some embodiments, 3D image data may be acquired by image device 102 directly via a 3D imaging technique such as LIDAR, confocal microscopy, RGB-D sensor, optical coherence tomography, holography, atomic force microscopy, phase interferometry, etc. In an embodiment using LIDAR, image device 102 transmits an amplitude modulated laser beam towards the scene containing the object of interest and measures the phase of the returning modulated reflected light energy. The phase difference of the transmitted and received modulation corresponds to the distance from the image device 102 to the spot in the scene. The laser beam can be scanned (e.g. mechanically) across the scene to construct a complete 3D image of the scene. In a further embodiment using confocal microscopy, image device 102 obtains images of an object at different depths and reconstructs 3D structures of the object using a process known as optical sectioning.

In a particular embodiment, image device 102 acquires 2D images, which are combined with local motion signals. 3D structures can then be estimated from the 2D image sequences using a “Structure-from-Motion” (“SFM”) or similar technique. With SFM, the intent is to capture details of a 3D object from as many orientations as possible. For example, image device 102 can acquire images while (i) rotating the object of interest; (ii) moving the object side-to-side; moving the image device 102 side-to-side; moving the image device 102 around the object; or (v) some combination of two or more of (i)-(iv). Reconstruction module 120 is configured to implement an SFM algorithm, which, at a high level, finds correspondence between images by selecting boundaries, corner points, edges and blobs that have gradients in multiple directions and which can be tracked from one image to the next. In some implementations, image device 102 comprises a mobile device, such as a cellular phone, that is equipped with a high resolution digital camera, providing a low-cost mechanism for capturing images for SFM. This can allow for developing mobile device-based client applications that can exploit other features such as an ability to capture and transmit images to cloud servers managing complex enterprise systems. A user can take several images of an object from various angles and send them to a 3D image reconstruction and object identification application (such as by system 100) for processing, thereby performing object classification tasks on the go. Such mobile device cameras may be capable of taking pictures with image metadata in “exchangeable image file format” (EXIF). The EXIF metadata tags can cover a broad spectrum including date and time information, geolocation information, image orientation and rotation, camera settings such as focal length, aperture, shutter speed, metering mode, ISO, etc. The EXIF information can be used for calibrating images acquired by image device 102, which can better facilitate reconstruction of 3D images from the acquired images by the system 100.

In alternative embodiments, reconstruction module 120 can be configured to perform 3D reconstruction according to other techniques. Multiple cameras 102 or a single camera 102 may acquire images from a fixed location or multiple locations while illumination and/or camera characteristics are tweaked. Such techniques may include shape from focus, shape from shading, and stereoscopy. “Shape-from-Focus” may be used if the scene being imaged has features such as edges or textures that can be imaged with a lens having a very short depth-of-field and where the lens can be moved through a range of focus. In such a case, the focus distance that gives the sharpest image of a feature corresponds to the distance from the image device 102 to that feature. This can allow grouping of points that lie in the same focal plane; however, it may not alleviate issues of occlusion. “Shape-from-Shading” may be used where the object of interest's surface has known reflectance characteristics. The object is illuminated with a light source of known direction and intensity, and the brightness of the surface in the acquired image corresponds to its distance and surface orientation relative to the light source and camera 102. Interpreting gray values from surfaces in an appropriately illuminated image gives the distance of the surface from the camera 102 and light. With stereoscopy, two or more cameras 102 simultaneously image the scene. The differences in location of a feature in each acquired image provides information about the separation of each point, both laterally and in depth, allowing a 3D image to be reconstructed.

The system 100 may implement one or more deep learning neural network techniques, such as a convolutional neural network (“CNN”). The system 100 may be used to segment, identify, and classify an object in a 3D image. Segmenting, identifying, and classifying a 3D image may avoid issues associated with applying the same techniques to 2D images, such as occlusion or nearby clutter. For example, in a 2D image, occlusion can occur where the object of interest is blocked or overlapped by another object when viewed from a certain angle; self-occlusion can occur where the object of interest blocks relevant features of itself that are crucial for identification when viewed from a certain angle; and poor lighting such as glare and backlight can result in overexposure or underexposure respectively in certain scenes can lead to missing details thus making the image unusable. System 100 can overcome such disadvantages by adding depth information to a scene through the 3D reconstruction process and generating a 3D image of the object of interest. To do this, image device 102 can be configured to acquire multiple 2D images of a scene from different vantage points in order to acquire necessary depth information to reduce occlusion and cluttering effects.

Artificial intelligence (AI) module 118 may be configured to carry out segmentation on a reconstructed 3D image. Segmentation comprises isolating patterns in the reconstructed image that can potentially be classified as the object of interest (in and object identification and classification application) or a defined defect (in a defect detection and localization application). Segmentation can reduce extraneous data about patterns whose classes are not desired to be known. Segmenting the reconstructed 3D image may include application of one or more segmentation algorithms, for example, region growing RANSAC, Hough Transform, watershed, hierarchical clustering, iterative clustering, or the like. The AI module 118 may implement one or more algorithms to segment the object of interest in a 3D image.

AI module 118 may comprise a neural network trained on reconstructed multi-orientation 3D representations or multi-view 2D projections. The trained neural network can be used to identify and classify objects in their (i) reconstructed multi-orientation 3D representations, or (ii) multi-view 2D projections, or (iii) static 2D images. In some embodiments, the static 2D images comprise the input 2D images used to reconstruct the 3D image using SFM or other technique.

The AI module 118 can use machine learning (ML) to transform raw data from a reconstructed 3D image of the scene into a descriptor. The descriptor may be information associated with a particular type of object (e.g. object identification/classification) or particular defect in the object. The descriptor can then be used by the AI module 118 to determine a classifier for the object or defect. As an example, the AI module 118 can do this detection and classification with auto-encoders as part of a deep belief network. In this sense, ML can be used as part of a feature descriptor extraction process, otherwise called “feature learning”. In some cases, the AI module can perform the machine learning remotely over a network to a system located elsewhere.

In further embodiments, instead of, or along with, feature learning, “feature engineering” can also be undertaken by the AI module 118 to determine appropriate values for discrimination of distinct classes in the reconstructed 3D image data. The AI module 118 can then use ML to provide a posterior probability distribution for class assignment of the object to the class labels. In some cases, “feature engineering” can include input from a user such as a data scientist or computer vision engineer.

In an embodiment, the AI module 118 can provide class labels of types of objects. For example, in a machine part identification and classification application used as part of a tool inventory verification process, the class labels may comprise tool types. In another embodiment, the AI module can provide class labels of types of defects. In a simplified case, the labels can include “defect” and “acceptable”. In another case, labels can represent a particular type of defect. For example, in a contact lens inspection and defect detection application, the AI module 118 may provide class labels of “hole”, “tear”, “rip”, “missing”, etc. Once generated by AI module 118, class labels can then be provided to the output interface 110.

The determinations of the AI module 118 can be outputted via the output interface 110 in any suitable format; for example, images, graphs, alerts, textual information, or the like. In further embodiments, the determinations can be provided to other systems or machinery.

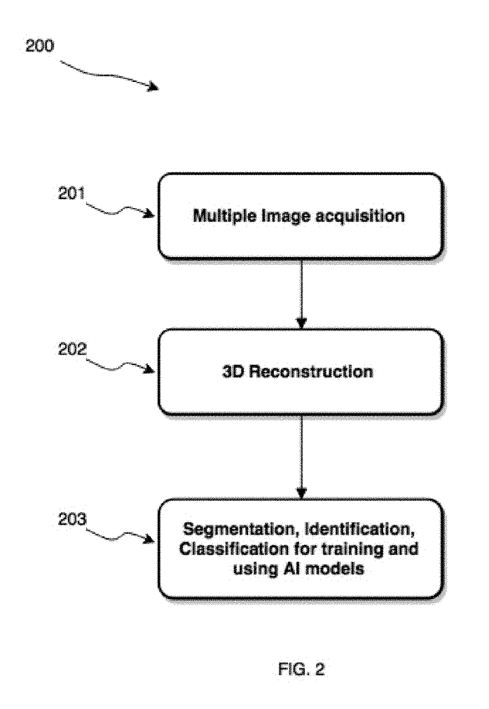

Referring now to FIG. 2, shown therein is a method 200 for identifying and classifying an object of interest, in accordance with an embodiment. Method 200 may be implemented using the image device 102 and the system 100 of FIG. 1. Method 200 can be used to verify the identity of an object of interest present in an imaged scene. At block 201, multiple images of the scene containing the object of interest are acquired using one or more image devices 102. The multiple images can be acquired from multiple views or perspectives. The multiple images can be transmitted to system 100, where they are received by input interface 108 and communicated to the reconstruction module 120. At block 202, a 3D image of the scene or of the object of interest is reconstructed using the multiple acquired images. The reconstruction may be accomplished according to SFM or other 3D reconstruction techniques, such as those described herein. The reconstructed 3D image can be provided to the AI module 118. At block 203, the reconstructed 3D image is segmented, identified and classified. Segmentation may be carried out according to one or more segmentation techniques described herein. Identification and classification may be carried out according to techniques described herein; for example, a neural network can be trained to classify the object of interest based on the reconstructed 3D image. Training may be based on reconstructed multi-orientation 3D representations of objects or their multi-view 2D projections. The object is then classified using the trained neural network.

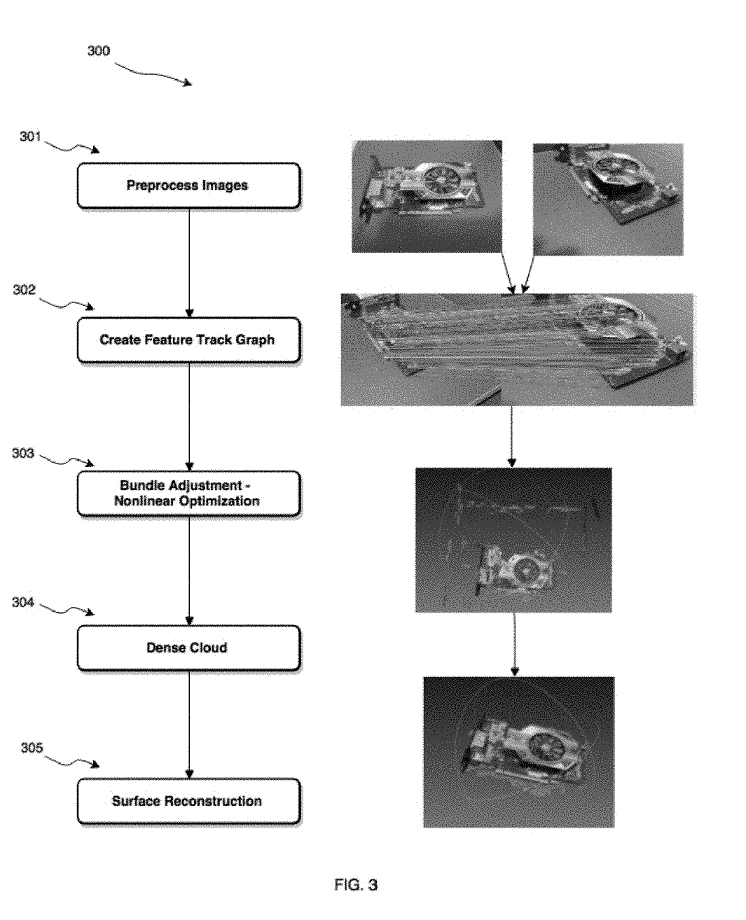

Referring now to FIG. 3, shown therein is a method 300 for 3D reconstruction of a scene from multiple 2D images, in accordance with an embodiment. Method 300 may be implemented as part of 3D reconstruction module 120. The multiple 2D images, or “image set”, may be acquired from multiple vantage points by one or more image devices 102, and provided to neural network system 100 for reconstruction, object identification, and object classification. The images forming the image set may be acquired under different conditions and stored in one or more image formats, and may be provided to system 100 via input interface 114. At block 301, the images in the image set are pre-processed. Pre-processing in some embodiments may include generating high dynamic range images by combining multiple low dynamic range images acquired at different exposure levels. Other preprocessing techniques may be used such as colour balancing, exposure equalization, local and global contrast enhancement, denoising, colour to grayscale conversion, and the like. At block 302, feature detection is performed on the image set. In doing so, image processing techniques are applied to an image to detect salient features in the image that have high contrast, such as corners, edges, blobs, and lines. These features have a high likelihood of being easily identifiable in adjacent images for the purpose of feature tracking across multiple images (i.e. such as across an image pair). Feature tracking across multiple images facilitates point correspondence and relative pose estimation, which can be performed incrementally or globally. At block 303, camera poses and 3D points are jointly estimated through an optimization process. The optimization process, known as “bundle adjustment”, seeks to minimize the projection errors of point onto an image given an estimated pose, and by doing so produces a sparse point cloud. At block 304, the sparse point cloud generated from point correspondences is made denser using one or more techniques such as patch matching. At block 305, surface reconstruction is performed on the point cloud (once dense enough).

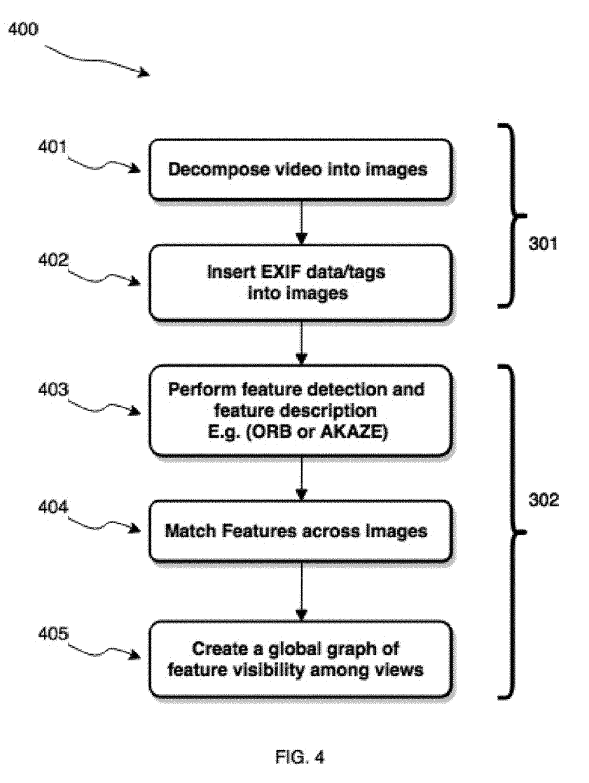

Referring now to FIGS. 4 to 6, certain steps of method 300 for 3D reconstruction are described in further exemplary detail. The steps of the methods described in FIGS. 4 to 6 may be implemented as part of 3D reconstruction module 120 of system 100.

Turning first to FIG. 4, the steps of pre-processing 301 and feature detection/extraction 302 are shown in greater detail. The steps shown in FIG. 4 correspond to an embodiment wherein image device 102 is a video camera; however, with appropriate modifications image device 102 could be any suitable imaging device. The video camera 102 acquires a video sequence of a scene, the scene containing an object of interest, and the video sequence is provided to system 100. At block 401, the video sequence is decomposed into a plurality of images. At block 402, metadata such as EXIF data/tags are inserted into the plurality of images. Metadata may include resolution, lens information, focal length, sensor width, or the like. Metadata/EXIF data can be used to extrapolate camera calibration in order to perform a 3D spatial alignment procedure, which determines the relative location of the image device 102 in the 3D point cloud being reconstructed and estimates the camera poses (i.e. the position and orientation of the image device 102 when an image was acquired). At block 403, feature detection and description is performed on each image to extract features. Feature detection can be performed by examining key points in an image. Key points represent location in an image that a surrounded by distinctive texture; key points are preferably stably defined in the images, scalable, and reproducible under varying imaging conditions. Key points may be selected that have high repeatability across multiple images in an image set due to invariance to changes in illumination, image noise, geometric transformation such as scaling, translation, shearing, and rotation. Feature detection may utilize binary descriptors; for example, binary robust independent elementary features (BRIEF), binary robust invariant scalable keypoints (BRISK), oriented fast and rotated BRIEF (ORB), Accelerated KAZE (AKAZE), fast retina keypoint (FREAK), or other techniques. At block 404, the features can be mapped across the image set in order to reconstruct the 3D image. One or more feature descriptor techniques may be used to determine which key points in various images in the image set are 2D representations of the same 3D point; for example, gradient location and orientation histogram (GLOH), speeded-up robust features (SURF), scale-invariant feature transform (SIFT), histogram of oriented gradients (HOG), or the like. This can be done by computing a feature vector or feature descriptor with local characteristics to describe a local patch. Feature descriptors are matched between different images in the image set by associating key points from one image to another in the set. At block 405, once all the feature descriptors are matched, a global map of feature visibility among views can be created.

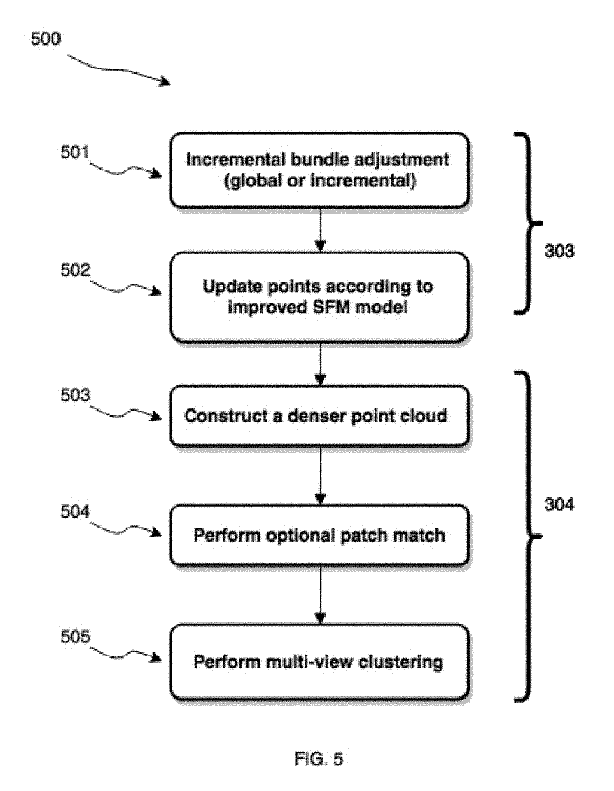

Referring now to FIG. 5, shown therein are the steps of optimization 303 and increasing point cloud density 304 of method 300 in greater detail, in accordance with an embodiment. At block 501, a non-linear optimization step called “bundle adjustment” is performed on the image set to jointly refine relative poses of the image devices 102 and the 3D position of points. This step provides information regarding (i) the location of the image devices 102 and their orientation in a local reference frame, which may be determined with respect to a reference image device, and (ii) where a given image device 102 is with respect to the 3D object—i.e. what was the location and orientation of that particular imaging device to create that particular 2D image on which the features were detected (at step 302). Bundle adjustment may be performed incrementally or globally to minimize projection errors of points onto an image given an estimated pose, with respect to camera matrices and key points. From this, a sparse point cloud is produced at block 502. Upon bundle adjustment, knowing the orientation of the images, a texture-mapped dense 3D point cloud is created at block 503. The point density may also be increased by interpolating the sparse point cloud. At block 504, an even denser point cloud may be constructed via patch match or other similar technique, whereby regions are matched around features. This may be done using normalized cross correlation or other advanced method(s). Patches around different keypoints are compared across multiple views based on similarity. If the similarity of the patches from multiple views is within a threshold, it can be added to the point cloud to fill it out. These patches propagate to the point cloud and soon the sparse structure becomes dense enough to be able to make out what is in the scene. In some scenarios, it may not be possible to handle a large number of images for a global 3D scene reconstruction due to limitation on computational or memory resources. In such a scenario, the input images may be decomposed into set of image clusters of manageable size based on their proximity to other camera views, as determined by the bundle adjustment process. A dense point cloud can then be generated for each cluster independently and in parallel. At block 505, multiview clustering is performed, wherein the union of reconstructions from all the clusters recreates the entire 3D image.

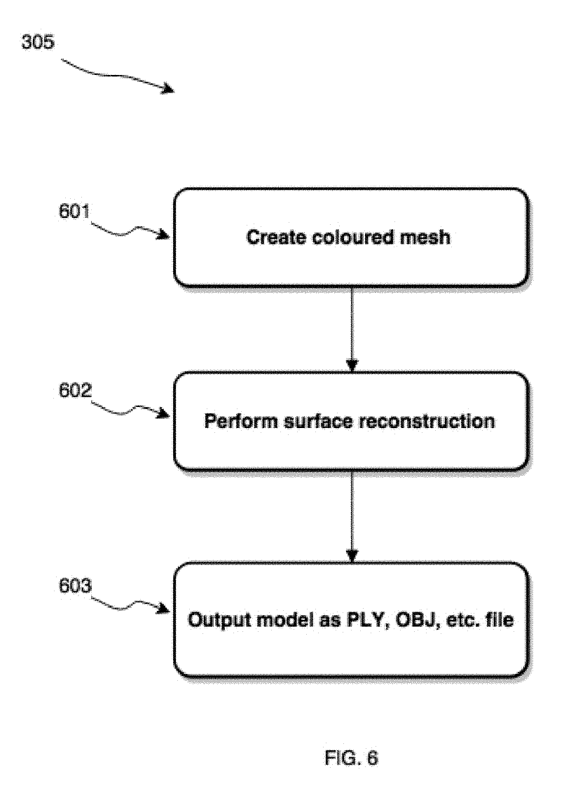

Turning now to FIG. 6, the steps of surface reconstruction 305 are described in greater detail, in accordance with an embodiment. Once a sufficiently dense point cloud of the scene is produced (such as at block 505), surface reconstruction can be initiated. If the input point cloud for the surface reconstruction process is noisy, a surface fitting the points of the point cloud may be too bumpy for practical use. At block 601, noise can be removed by applying a denoising filter to the point cloud, such as a Poisson filter, Voronoi filter, ball pivoting, or the like, in order to create a mesh. At block 602, the surfaces of 3D objects are incrementally reconstructed using techniques such as mesh sweeping and photometric refinement, which can fuse geometric and photometric cues for subpixel refinement of shape and depth. At block 603, the reconstructed 3D image can be exported to AI module 118 in one or more formats such as PLY, OBJ, P4B, or the like, and saved as a computer-readable file.

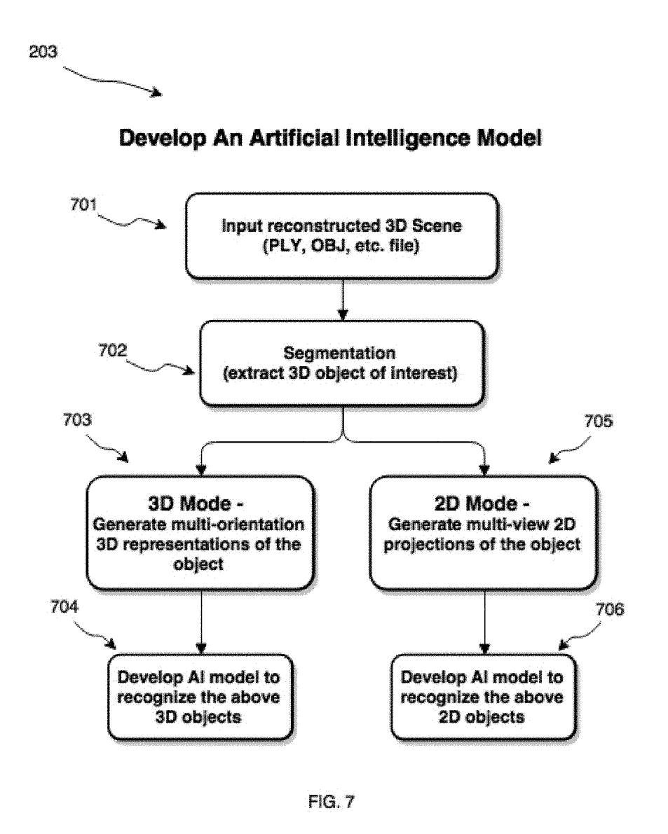

Referring now to FIGS. 7 to 9, methods for training and using an AI model for classifying objects are shown. Particularly, FIGS. 7 to 9 provide greater detail on classification step at block 203 of method 200. The steps of the methods described in FIGS. 7 to 9 may be implemented as part of AI module 118. AI module 118 may be configured to: train a neural network based on (i) multi-orientation 3D representations of the object of interest generated from the reconstructed 3D image and/or (ii) multi-view 2D projections of the object of interest generated from the reconstructed 3D image; and classify using the trained neural network and using as inputs at least one of (i) multi-orientation 3D representations of the object of interest generated from the reconstructed 3D image, (ii) multi-view 2D projections of the object of interest generated from the reconstructed 3D image, and (iii) original 2D images such as acquired at block 201.

Particularly, the neural network can be trained to perform classification via a classifier. The term “classifier” as used herein means any algorithm, or mathematical function implemented by a classification algorithm, that implements a classification process by mapping input data to a category. The term “classification” as used herein should be understood in a larger context than simply to denote supervised learning. By classification process we convey: supervised learning, unsupervised learning, semi-supervised learning, active/groundtruther learning, reinforcement learning and anomaly detection. Classification may be multi-valued and probabilistic in that several class labels may be identified as a decision result; each of these responses may be associated with an accuracy confidence level. Such multi-valued outputs may result from the use of ensembles of same or different types of machine learning algorithms trained on different subsets of training data samples. There are various ways to aggregate the class label outputs from an ensemble of classifiers; majority voting is one method. The AI module 118 can use ML to provide a posterior probability distribution for class assignment of the object to the class labels. In supervised or semi-supervised machine learning, a “class label” comprises a discrete attribute that the machine learning system predicts based on the value of other attributes. A class label takes on a finite (as opposed to infinite) number of mutually exclusive values in a classification problem.

The machine-learning based analysis of the AI module 118 may be implemented by providing input data to the neural network, such as a feed-forward neural network, for generating at least one output. The neural networks described herein may have a plurality of processing nodes, including a multi-variable input layer having a plurality of input nodes, at least one hidden layer of nodes, and an output layer having at least one output node. During operation of a neural network, each of the nodes in the hidden layer applies a function and a weight to any input arriving at that node (from the input layer or from another layer of the hidden layer), and the node may provide an output to other nodes (of the hidden layer or to the output layer). The neural network may be configured to perform a regression analysis providing a continuous output, or a classification analysis to classify data. The neural networks may be trained using supervised or unsupervised learning techniques, as described above. According to a supervised learning technique, a training dataset is provided at the input layer in conjunction with a set of known output values at the output layer. During a training stage, the neural network may process the training dataset. It is intended that the neural network learn how to provide an output for new input data by generalizing the information it learns in the training stage from the training data. Training may be affected by backpropagating error to determine weights of the nodes of the hidden layers to minimize the error. The training dataset, and the other data described herein, can be stored in the database 122 or otherwise accessible to the system 100. Once trained, or optionally during training, test data can be provided to the neural network to provide an output. A neural network may thus cross-correlate inputs provided to the input layer in order to provide at least one output at the output layer. Preferably, the output provided by a neural network in each embodiment will be close to a desired output for a given input, such that the neural network satisfactorily processes the input data.

In some variations, the neural network can operate in at least two modes. In a first mode, a training mode, the neural network can be trained (i.e. learn) based on known 2D or 3D images. The training typically involves modifications to the weights and biases of the neural network, based on training algorithms (e.g. backpropagation) that improve its detection capabilities. In a second mode, a normal mode or use mode, the neural network can be used to identify and classify an object or detect a defect and potentially classify the defect. In variations, some neural networks can operate in training and normal modes simultaneously, thereby both classifying an object of interest, and training the network based on the classification effort performed at the same time to improve its classification capabilities. In variations, training data and other data used for performing detection services may be obtained from other services such as databases 122 or other storage services. Some computational paradigms used, such as neural networks, involve massively parallel computations. In some implementations, the efficiency of the computational modules implementing such paradigms can be significantly increased by implementing them on computing hardware involving a large number of processors, such as graphical processing units. In some cases, the training dataset can be imported in bulk from a historical database of images and labels, or feature determinations, associated with such images.

Turning first to FIG. 7, shown therein is a method for training an AI model for classifying an object of interest, in accordance with an embodiment. Method 700 may be implemented as part of AI module 118, to be executed by the system 100. In the present embodiment, AI module 118 can operate in two modes: a 3D mode and a 2D mode. In the 3D mode, the AI model, comprising a neural network, is trained to identify and classify an object based on a reconstructed multi-orientation 3D representation of the object being classified. The multi-orientation 3D representations are exactly the same as the reconstructed 3D image; however, some machine learning algorithms used to classify 3D objects can be sensitive to the orientation of the 3D object and thus to overcome this information from the 3D orientations is aggregated and presented to the neural network. This approach can be considered a form of view-pooling and data augmentation. In the 2D mode, the AI model is trained on multi-view 2D projections of the reconstructed 3D image.

At block 701, a reconstructed 3D image (such as produced at block 603 of FIG. 6) is input to the AI module 118. At block 702, the reconstructed 3D image is segmented using a segmentation algorithm to isolate and extract the object of interest from the “background” (i.e. unwanted objects in the image, clutter, etc.). Examples of segmentation algorithms include region growing, random sample consensus (RANSAC), Hough Transform, watershed, hierarchical clustering, iterative clustering, or the like. Blocks 703 and 704 illustrate training in 3D mode. At block 703, training data is augmented by generating multiple 3D representations of the extracted object of interest in varying orientations. At block 704, the neural network is trained to learn various 3D representations of the object using the multiple 3D representations as training data. Blocks 705 and 706 illustrate training in 2D mode. At block 705, multi-view 2D projections of the extracted object of interest are generated. At block 706, the neural network is trained using 2D images; the 2D images can be original 2D images and/or multi-view 2D projections generated from the extracted 3D object. In some embodiments, blocks 703-704 may occur simultaneously with blocks 705-706.

The neural network system 100 can be trained using a “volumetric” approach and/or a “multiple view” approach. In the volumetric approach, the reconstructed 3D image is split up into smaller cubes known as voxels, and the neural network is trained using the voxels as input. In the multiple view approach, the neural network is trained using 2D images from different views as input, where the 2D images are formed from the reconstructed 3D image using virtual cameras or other suitable technique. Classification can be used to classify an object of interest in the reconstructed 3D image. In a multiple view approach to classification, the input data is a 3D image that from which the system generates a plurality of views. The plurality of views are 2D images generated using a plurality of virtual cameras. Each 2D image has its own independently trained classifier. In an embodiment, n views are created from n virtual cameras and n+1 classifiers. The output from the set of independently trained classifiers can be aggregated and fed to a final classifier to produce a final classification output. Outputs from independently trained classifiers may be aggregated according to techniques known in the art as ensemble learning, ensemble averaging multiple classifier systems for aggregation of classification outputs. Specific examples of such technique that may be implemented by the system 100 include Bayes optimal classifier, bootstrap aggregation or bagging, boosting, Bayesian parameter averaging, Bayesian model combination, bucket of models, mixture of experts, hierarchical mixture of experts, and stacking.

Performing classification on reconstructed 3D images can present a challenge due to the “pose problem”, where objects can look completely different depending on the view point. Additionally, information about where the 3D model is being viewed from must be known. Using SFM to generate a reconstructed 3D image can address this challenge through a nonlinear optimization step known as bundle adjustment, which jointly refines the relative poses of a set of cameras and the 3D position of a point. Bundle adjustment can provide information on where the cameras are and their orientation in a local reference frame (e.g. measured from Camera 0). As well, bundle adjustment can provide information on where the camera is with respect to the 3D object (i.e. what was the camera's location and orientation to create that particular 2D image). A ‘front/back’ ‘left/right’ view of the object can be arbitrarily defined, allowing the neural network to be trained. In an embodiment, GPS coordinates stored in EXIF data in the image data may be used to work in a global coordinate system. With a local coordinate system, the first viewpoint of the camera (i.e. camera position 1) can be marked as the origin. It may be necessary to find camera 2 or viewpoint 2 in relation to camera position 1 through calculating the offset to the next viewpoint (i.e. pose estimation). The steps of pose estimation may be obviated with a global reference system, making the use of GPS advantageous.

In an embodiment using the volumetric approach, the pose problem may be separated into a separate classifier with a groundtruther loop to a data scientist having knowledge of the parts, classes, poses, etc. This may reduce the complexity and/or challenge presented by pose and normalize everything to a standard orientation.

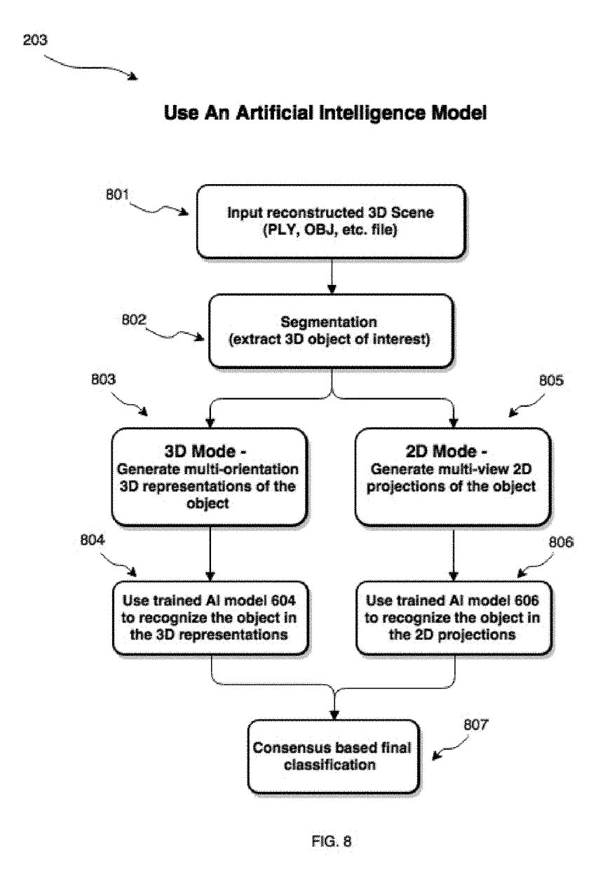

Referring now to FIG. 8, shown therein is a method for classifying an object using a neural network system 100 comprising a trained AI model, such as the trained AI model(s) from blocks 704 and 706 of method 700, in accordance with an embodiment. Generally, the AI module 118 of system 100 is configured to receive a reconstructed 3D input image containing the object of interest, segment the 3D image to extract the 3D object of interest, and generate a prediction of class label for the object of interest. At block 801, the 3D reconstructed image (exported from reconstruction module 120 at block 603) is imported to the AI module 118. At block 802, the 3D image is segmented using a segmentation algorithm, as described herein, to isolate and extract the object of interest. Once segmentation is complete, system 100 implementing method 800 can operate in two modes, a 3D mode and a 2D mode, as described in reference to FIG. 7 herein. In 3D mode, at block 803, multiple multi-orientation 3D representations of the extracted 3D object of interest are rendered, which can be presented to the trained AI model at block 804 in order to classify the 3D object. In 2D mode, at block 805, multiple multi-view 2D projections of the extracted 3D object of interest are rendered, which are presented to the AI model at block 806 to classify the object. The AI model at block 806 is trained to recognize and classify the object of interest in the 2D projections (such as trained AI model from block 706). At block 807, a final classification for the object of interest is determined by a weighted consensus method.

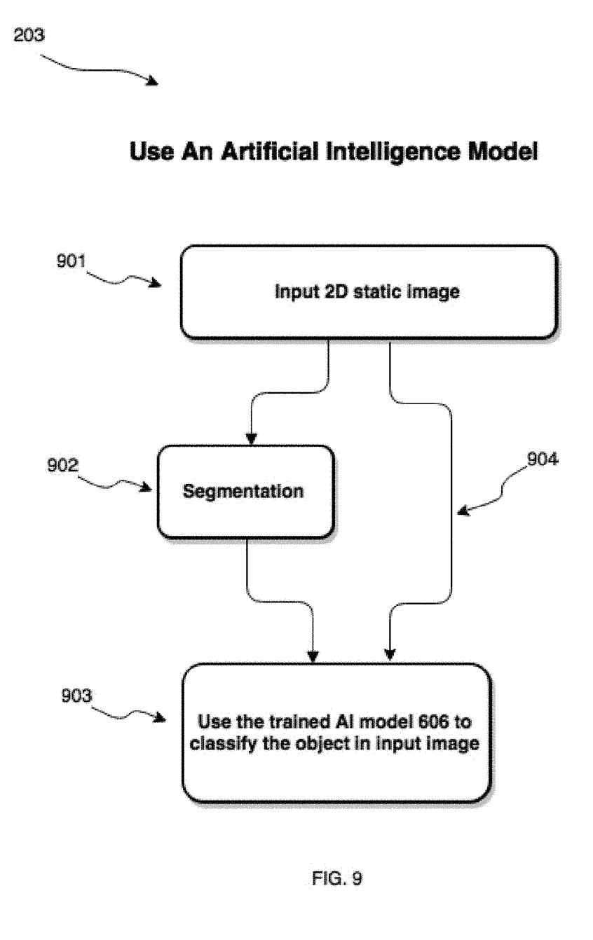

Referring now to FIG. 9, shown therein is a method for classifying an object using a neural network system comprising a trained AI model, in accordance with an embodiment. The method 900 may be implemented as part of AI module 118. The trained AI model is configured to identify and classify objects in a static 2D image. At block 901, the static 2D image is received by AI module 118. At block 902, the 2D image is segmented according to segmentation techniques described herein in order to extract the object of interest. At block 903, the extracted object of interest is presented to the trained AI model (such as AI model trained at block 706), which classifies the object of interest. In some embodiments, the static 2D image can be presented directly to the trained AI model for classification (bypassing the step at block 902).

In embodiments described herein, the AI module 118 can perform the detection by employing, at least in part, an LSTM machine learning approach. The LSTM neural network allows the system 100 to quickly and efficiently perform group feature selections and classifications.

The LSTM neural network is a category of neural network model specified for sequential data analysis and prediction. The LSTM however can be combined with convolutional neural networks to perform classification, where the LSTM is responsible for exploiting the sequentiality of multiple adjacent projections of a 3D object. The LSTM neural network comprises at least three layers of cells. The first layer is an input layer, which accepts the input data. The second (and perhaps additional) layer is a hidden layer, which is composed of memory cells (see FIG. 14). The final layer is output layer, which generates the output value based on the hidden layer using Logistic Regression.

Each memory cell, as illustrated, comprises four main elements: an input gate, a neuron with a self-recurrent connection (a connection to itself), a forget gate and an output gate. The self-recurrent connection has a weight of 1.0 and ensures that, barring any outside interference, the state of a memory cell can remain constant from one time step to another (e.g. adjacent frame, in one instance). The gates serve to modulate the interactions between the memory cell itself and its environment. The input gate permits or prevents an incoming signal to alter the state of the memory cell. On the other hand, the output gate can permit or prevent the state of the memory cell to have an effect on other neurons. Finally, the forget gate can modulate the memory cell's self-recurrent connection, permitting the cell to remember or forget its previous state, as needed.

Layers of the memory cells can be updated at every time step, based on an input array (e.g. the 2D projection of the 3D object). Using weight matrices and bias vectors, the values at the input gate of the memory cell and the candidate values for the states of the memory cells at the time step can be determined. Then, the value for activation of the memory cells' forget gates at the time step can be determined. Given the value of the input gate activation, the forget gate activation and the candidate state value, the memory cells' new state at the time step can be determined. With the new state of the memory cells, the value of their output gates can be determined and, subsequently, their outputs.

Based on the model of memory cells, at each time step, the output of the memory cells can be determined. Thus, from an input sequence, the memory cells in the LSTM layer will produce a representation sequence for their output. Generally, the goal is to classify the sequence into different conditions. The Logistic Regression output layer generates the probability of each condition based on the representation sequence from the LSTM hidden layer. The vector of the probabilities at a particular time step can be determined based on a weight matrix from the hidden layer to the output layer, and a bias vector of the output layer. The condition with the maximum accumulated probability will be the predicted outcome of this sequence.

In embodiments described herein, the AI module 118 can perform the segmentation, feature detection, or classification by employing, at least in part, a CNN machine learning approach.

CNN machine learning models are generally a neural network that is comprised of neurons that have learnable weights and biases. In a particular case, CNN models are beneficial when directed to extracting information from images. Due to the specificity of being directed to images, CNN models are advantageous because such models allow for a forward function that is more efficient to implement and reduces the amount of parameters in the network. Accordingly, the layers of a CNN model generally have three-dimensions of neurons called width, height, and depth; whereby depth refers to an activation volume. The capacity of CNN models can be controlled by varying their depth and breadth, such that they can make strong and relatively correct assumptions about the nature of images, such as stationarity of statistics and locality of pixel dependencies.

Typically, the input for the CNN model includes the raw pixel values of the input images. A convolutional layer is used to determine the output of neurons that are connected to local regions in the input. Each layer uses a dot product between their weights and a small region they are connected to in the input volume. A rectified linear units layer applies an element by element activation function, f(x)=max(0, x), to all of the values in the input volume. This layer increases the nonlinear properties of the model and the overall network without affecting the receptive fields of the convolutional layer. A pooling layer performs a down-sampling operation along the spatial dimensions. This layer applies a filter to the input volume and determines the maximum number in every subregion that the filter convolves around. As typically of a neural network, each output of a neuron is connected to other neurons with back-propagation.

While system 200 and various methods herein are described as using certain machine-learning approaches, specifically LSTM and CNN, it is appreciated that, in some cases, other suitable machine learning approaches may be used where appropriate.

The embodiments described herein include various intended advantages. As an example, quick determination of features of an object an interest, without necessitating costly and timely manual oversight or analysis of the truth of such feature.

While the above-described embodiments are primarily directed to identifying and classifying an object based on a reconstructed 3D image, those skilled in the art will appreciate that the same approach can be used for detecting other features of objects and used in various applications of 3D reconstruction and SFM.

The above described embodiments of the present disclosure are intended to be examples of the present disclosure and alterations and modifications may be effected thereto, by those of skill in the art, without departing from the scope of the present disclosure, which is defined solely by the claims appended hereto. For example, systems, methods, and embodiments discussed can be varied and combined, in full or in part.

Thus, specific systems and methods for increasing data quality for a machine learning process by ground truthing have been disclosed. It should be apparent, however, to those skilled in the art that many more modifications besides those already described are possible without departing from the inventive concepts herein. The subject matter of the present disclosure, therefore, is not to be restricted except in the spirit of the disclosure. Moreover, in interpreting the present disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A method for analysis of an object of interest in a scene using 3D reconstruction, the method executed on one or more processors, the method comprising:
receiving image data comprising a plurality of images captured of the scene, the image data comprising multiple perspectives of the scene;
generating at least one reconstructed image by determining three-dimensional structures of the object from the imaging data using a reconstruction technique, the three-dimensional structures comprising depth information of the object;
identifying the object from each of the reconstructed images, using a trained machine learning model, by segmenting the object in the reconstructed image, segmentation comprises isolating patterns in the reconstructed image that are classifiable as the object, the machine learning model trained using previous reconstructed multiple perspective images with identified objects; and
outputting the analysis of the reconstructed images.

2. The method of claim 1, wherein the generating at least one reconstructed image, further comprises:
detecting a plurality of features of the object, each of the features defining one or more key points, each of the features having a relatively high contrast for defining the one or more key points;
tracking the plurality of features across each of the plurality of images;
generating a sparse point cloud of the plurality of features using bundle adjustment with respect to a local reference frame;
densifying the sparse point cloud; and
performing surface reconstruction on the densified point cloud.

3. The method of claim 2, wherein detecting the plurality of features comprises utilizing one or more binary descriptors selected from the group consisting of binary robust independent elementary features (BRIEF), binary robust invariant scalable keypoints (BRISK), oriented fast and rotated BRIEF (ORB), Accelerated KAZE (AKAZE), and fast retina keypoint (FREAK).

4. The method of claim 2, wherein tracking the plurality of features across each of the plurality of images comprises associating key points from each of the plurality of images to a same three-dimensional point by utilizing at least one of gradient location and orientation histogram (GLOH), speeded-up robust features (SURF), scale-invariant feature transform (SIFT), and histogram of oriented gradients (HOG).

5. The method of claim 2, wherein the local reference frame comprises a location and orientation of one or more imaging devices used to capture the plurality of images.

6. The method of claim 5, wherein densifying the sparse point cloud comprises comparing patches around at least some of the key points across multiple perspectives for similarity and where the similarity of the patches from multiple perspectives is within a predetermined threshold, adding such patches to the point cloud.

7. The method of claim 2, wherein the analyzing of each of the reconstructed images further comprises pre-processing of at least one of the plurality of images using one or more pre-processing techniques, the pre-processing techniques selected from a group consisting of decomposing a video sequence into the plurality of images, generating high dynamic range images by combining multiple low dynamic range images acquired at different exposure levels, color balancing, exposure equalization, local and global contrast enhancement, denoising, and color to grayscale conversion.

8. The method of claim 1, wherein trained machine learning model takes as input and is further trained using multiple perspective two-dimensional projections of objects generated from the reconstructed image.

9. The method of claim 8, wherein each two-dimensional projection has associated with it an independently trained classifier in the trained machine learning model to identify the object, and wherein each of the independently trained classifiers are aggregated and fed to a final classifier to produce a final classification to identify the object.

10. The method of claim 1, wherein identifying the object from each of the reconstructed images, using a trained machine learning model, comprises splitting the reconstructed image into a plurality of voxels, and training the machine learning model using the voxels.

11. The method of claim 2, wherein the segmentation comprises using at least one of RANSAC, Hough Transform, watershed, hierarchical clustering, and iterative clustering.

12. A system for analysis of an object of interest in a scene using 3D reconstruction, the system comprising one or more processors, a data storage device, an input interface for receiving image data comprising a plurality of images captured of the scene, and an output interface to output the analysis, the image data comprising multiple perspectives of the scene, the one or more processors configured to execute:
a reconstruction module to generate at least one reconstructed image by determining three-dimensional structures of the object from the imaging data using a reconstruction technique, the three-dimensional structures comprising depth information of the object; and
an artificial intelligence module to identify the object from each of the reconstructed images, using a trained machine learning model, by segmenting the object in the reconstructed image, segmentation comprises isolating patterns in the reconstructed image that are classifiable as the object, the machine learning model trained using previous reconstructed multiple perspective images with identified objects provided to the artificial intelligence module.

13. The system of claim 12, wherein the image data from each of the different perspectives is captured using a different image acquisition device.

14. The system of claim 12, wherein the image data from each of the different perspectives is captured using a single image acquisition device sequentially moved to each perspective.

15. The system of claim 12, wherein each of the plurality of images have exchangeable image file format (EXIF) data associated with it, the EXIF data comprising at least one of date and time information, geolocation information, image orientation and rotation, focal length, aperture, shutter speed, metering mode, and ISO, and wherein the reconstruction module uses the EXIF data to calibrate the plurality of images to facilitate reconstruction.

16. The system of claim 12, wherein the reconstruction module determines the three-dimensional structures using a structure-to-motion technique, the structure-to-motion technique uses the plurality of images captured of the object in a plurality of orientations, determines correspondences between images by selecting relatively high-contrast that have gradients in multiple directions, and tracks such correspondences across images.

17. The system of claim 12, wherein the reconstruction module determines the three-dimensional structures using a shape-from-focus technique, the shape-from-focus technique uses the plurality of images captured with an image acquisition device having a very short depth-of-focus, where the plurality of images are captured with such lens moving through a range of focus, the reconstruction module determines a focal distance that provides the sharpest image of a plurality of features of the object and corresponds such distance to that feature of the object.

18. The system of claim 12, wherein the reconstruction module determines the three-dimensional structures using a shape-from-shading technique, the surface of the object having a known reflectance, the shape-from-shading technique using the plurality of images captured by a plurality of image capture devices using illumination from a light source of known direction and intensity, where a brightness of the surface of the object corresponds to a distance and surface orientation relative to the light source and the respective image acquisition device, the reconstruction module determining gray values from each respective surface to provide a distance to the object, where each of the image capture devices approximately simultaneously image the scene and differences in location of each feature in each acquired image provide separation of each point in three-dimensional space.

19. The system of claim 12, wherein the reconstruction module generates the at least one reconstructed image by:
detecting a plurality of features of the object, each of the features defining one or more key points, each of the features having a relatively high contrast for defining the one or more key points;
tracking the plurality of features across each of the plurality of images;
generating a sparse point cloud of the plurality of features using bundle adjustment with respect to a local reference frame;
densifying the sparse point cloud; and
performing surface reconstruction on the densified point cloud.

20. The system of claim 12, wherein trained machine learning model takes as input and is further trained using multiple perspective two-dimensional projections of objects generated from the reconstructed image.
